(19) United States
(12) Patent Application Publication
(10) Pub. No.: US 2003/0163391 A1
(43) Pub. Date: Aug. 28, 2003

(54) Computerized method, system and computer-readable medium for individualized ordering and billing of packages of goods

(76) Inventors: John Thomas Elkins, Louisville, KY (US); Robert Quigley, Louisville, KY (US); Christi Dale Wantuck, Louisville, KY (US); Robert T. Dupin, La Grange, KY (US); Joseph Lyon Miles, Louisville, KY (US); Sharon True Blair, Louisville, KY (US); Patricia Ann Vittitoe, Louisville, KY (US); Angela M. Abell, Louisville, KY (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/083,882

(22) Filed: Feb. 27, 2002

(51) Int. Cl. G06F 17/60

(52) U.S. Cl. 705/27

(57) ABSTRACT

Computerized method, system and computer-readable medium are provided for ordering and billing goods and services in connection with the goods. Each embodiment is customized to meet the individualized needs of users in respective market segments by enabling ordering of packages of the goods. The method allows providing a user-interface to each user configured to enable the user to define at least one package identifier associated with a respective set of goods and/or services of interest to each respective user. The method further allows populating a database with at least one parameter comprising respective model identifier and service code for each good and/or service associated with each respective package identifier. The database is accessed in view of each defined package identifier to retrieve the at least one parameter for each respective package identifier. Each user-selected package of goods and/or services is processed based on a selected package identifier to generate in order of the goods and/or services associated with the selected package identifier.

### BACKGROUND OF THE INVENTION

The present invention is generally related to computerized system and techniques for facilitating E-commerce transactions, and, more particularly, to computerized method and system for ordering and billing goods and services. The method and system are customized to meet the individualized needs of users in respective market segments, such as residential construction, by allowing innovative means for ordering and billing packages or groups of goods, such as appliances, lighting equipment and/or services in connection with the goods.

One or more of the business components (e.g., GE Appliances, GE Lighting) of the assignee of the present invention purvey in commerce consumer goods, such as household appliances, lighting equipment, (and services in connection with such goods) to a variety of purchasers, such as individual purchasers, large wholesalers, distributors, and purchasers including home builders that may have specialized needs in connection with the ordering and billing process of such goods and/or services. Present billing and ordering techniques of household appliances in the context of home building applications have generally relied on manually performed processes that are somewhat error prone. Further, present ordering techniques have generally required the builder, either directly, or through order entry personnel, to identify each product line of interest by model numbers or identifiers that may have little, if any resemblance, to the designations used by the home builder in their marketing materials. The builder also needs to remember unfamiliar service codes for ordering related services.

Thus, it would be desirable to increase the accuracy and ease with which builders order appliances from appliance manufacturers, such as the assignee of the present invention. For example, it would be desirable allowing the builder to order product and services by predefined package of goods instead of ordering by individual models and services. It would be further desirable to provide ordering techniques adaptable to any medium of choice for any given builder, such as telephone, facsimile, or any suitable communications network, e.g., Internet, Intranet, etc. It would also be desirable for the builder to be able to choose specific appliance upgrades and appliance options and related services without having to supply the manufacturer's model numbers.

As suggested above, another area that may facilitate the builder to more efficiently manage its business operations deals with billing. For example, it would be desirable for the builder to be able to choose from several invoice templates or formats based upon their unique billing needs. It would be particularly desirable to be able to quickly and accurately differentiate between costs associated with a standard package of goods versus an upgraded package of goods. This aspect of billing is generally known as differential billing and is one basic component in the building industry for cost tracking purposes.

Thus, it would be desirable to provide innovative system and techniques that allow the supplier of the goods to communicate with the builder in a more user-friendly language and move away from retail-oriented ordering and billing techniques. The inventors of the present invention have innovatively recognized the use of computerized business tools and techniques that facilitate the storage and processing of customer-specific product and/or service needs to be used for ordering and billing. Such tools and techniques would allow customers, sales and order service personnel to quickly and accurately capture this information in a package or list format with various options including individualized naming of the packages of goods and configuring any desired package upgrade from a standard package of goods. Moreover, such tools and techniques would allow each customer to set an individualized selling strategy appropriate to their respective construction project and would allow for simplified ordering and billing capabilities.

It is believed that prior to the present invention there has not been any systematic means for capturing this individualized information for each customer. This innovative process and system will advantageously allow customers to order by predefined packages, as defined by each user, and will allow billing to be automatically generated based on information stored in the system. One will now be able to display incremental costs on invoices based on data indicative of the unique needs of any given builder. In the past, both the ordering and billing techniques fell short to fully meet the needs of builders since such techniques generally relied on burdensome manual processes, which had high opportunities for human error. In view of the foregoing considerations, there is a need for computerized system and techniques configured to meet the specialized needs of market segments, such as the building industry, and the business operations such industry follows.

### BRIEF SUMMARY OF THE INVENTION

Generally, the present invention fulfills the foregoing needs by providing in one aspect thereof, a computerized method for ordering and billing goods and services in connection with the goods. The method is customized to meet the individualized needs of users in respective market segments by enabling ordering of packages of the goods. The method allows providing a user-interface to each user configured to enable the user to define at least one package identifier associated with a respective set of goods and/or services of interest to each respective user. The method further allows populating a database with at least one parameter comprising respective model identifier and service code for each good and/or service associated with each respective package identifier. The database is accessed in view of each defined package identifier to retrieve the at least one parameter for each respective package identifier. Each user-selected package of goods and/or services is processed based on a selected package identifier to generate an order of the goods and/or services associated with the selected package identifier.

The present invention further fulfills the foregoing needs by providing in another aspect thereof, a computerized system for ordering and billing goods and services in connection with the goods. The system is customized to meet the individualized needs of users in respective market segments by enabling ordering of packages of the goods. The system includes a user-interface configured to enable the user to define at least one package identifier associated with a respective set of goods and/or services of interest to each respective user. The system further includes a database with at least one parameter comprising respective model identifier and service code for each good and/or service associated with each respective package identifier. An input/output device is configured to access the database in view of each defined package identifier to retrieve the at least one parameter for each respective package identifier. A processor is configured to process a user-selected package of goods and/or services based on a selected package identifier to generate an order of the goods and/or services associated with the selected package identifier.

In yet another aspect thereof, the present invention provides a computer-readable medium for ordering and billing goods and services in connection with the goods. The computer-readable medium includes instructions causing a computer to facilitate meeting the individualized needs of users in respective market segments that generally order packages of the goods by:

configuring a user-interface to enable each user to define at least one package identifier associated with a respective set of goods and/or services of interest to each respective user;

populating a database with at least one parameter comprising respective model identifier and service code for each good and/or service associated with each respective package identifier;

accessing the database in view of each defined package identifier to retrieve the at least one parameter for each respective package identifier; and

processing a user-selected package of goods and/or services based on a selected package identifier to generate an order of the goods and/or services associated with the selected package identifier.

### BRIEF DESCRIPTION OF THE DRAWINGS

The features and advantages of the present invention will become apparent from the following detailed description of the invention when read with the accompanying drawings in which:

FIG. 1 illustrates a schematic representation of an exemplary computerized system that may be used for practicing a computerized method for ordering and billing goods in accordance with aspects of the invention.

FIG. 2 illustrates an exemplary user interface configure to allow each user to define and select a respective package identifier for ordering a package of goods or services in lieu of specific model numbers or service codes.

FIG. 3 illustrates the user-interface of FIG. 2 configured to display exemplary model identifiers associated with an exemplary package identifier.

FIG. 4 is a flow chart of exemplary actions that may be performed in the context of an ordering and billing process embodying aspects of the present invention.

FIGS. 5-13 show various exemplary invoice formats that may be selected by the user, and including a differential billing format that advantageously allows users for quickly and accurately differentiating between costs associated with a standard package of goods versus an upgraded package of goods.

### DETAILED DESCRIPTION OF THE INVENTION

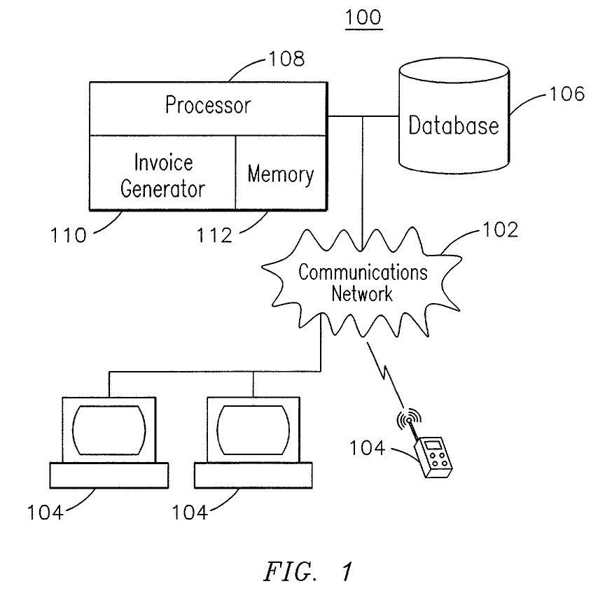

FIG. 1 illustrates a schematic representation of an exemplary system 100 that may be used for practicing a computerized method for ordering and billing goods, such as household appliances, lighting equipment, etc., and services in connection with the goods. As suggested above, the method is customized to meet the individualized needs of users in respective market segments, such as residential construction, that may benefit from techniques that enable such users to order packages of the goods. As used herein, the term “package” refers to a group or set of goods, services, or both, that may be collectively designated by a purchaser to fulfill the needs of a given business project, such as a package of appliances offered by the builder for a given residential unit. The term should be broadly construed and should not be limited in the sense of a physical containment package. System 100 includes devices that cooperate in a manner that, in one exemplary embodiment, allow for seamlessly integrating a plurality of users through a communications network 102, such as a local area network (LAN), wide area network (WAN), intranet, or the Internet. In one exemplary embodiment, remote terminals 104 using commercially available browsers, and Web-based applications may be provided to each user. The remote terminal may comprise a personal computer, a laptop computer, a personal digital assistance (PDA) device, cellular telephone, facsimile, or any other wired or wireless device that enables communication of information.

In one exemplary embodiment, a user-interface device, through any of remote terminals 104, may be configured to display a Web page configured to enable each user to define at least one package identifier associated with a respective set of goods and/or services of interest to each respective user. For example, a builder may define the identifier “Canterbury” to identify a respective package of goods for houses that builder markets as “Canterbury” housing. That same builder may define the term “Blue Woods” for identifying a respective package of goods for residential units that builder markets as “Blue Woods” residential development. Each builder will likely use different expressions to uniquely identify any desired combinations of good and/or services offered under each respective package identifier, limited only by the imagination of each builder. Once again, it is believed that this feature for ordering packages using terminology selected by the purchaser in lieu of the generic model numbers of each appliance will greatly simplify the ordering process and will allow the builder to use the same terminology the builder uses with her customers.

System 100 further includes a database 106 populated with at least one parameter, such as respective model identifier and service code for each good and/or service associated with each respective package identifier. For example, the “Canterbury” package may include respective model identifiers for an electric range, and a shelf-mounted microwave, while the “Blue Woods” package may include respective model identifiers for a gas range, a venting hood, and a shelf-mounted microwave with roasting capability. Each remote terminal 104 may also be operable an input/output device configured to provide access to database 106 to access the database in view of each defined package identifier to retrieve parameters of interest for each respective package identifier. It will be appreciated that database 106 may be further populated with detailed information for the goods in each package. For example, footprint requirements, installation notes, etc. In this manner, the builder would be able to readily determine the specific details regarding any given package of goods and/or services.

A processor 108 is configured to process a user-selected package of goods and/or services based on a selected package identifier to generate an order of the goods and/or services associated with the selected package identifier. For example, if the user selects the “Canterbury” package, then processor 108 will generate an order for the respective goods and/or services associated with the “Canterbury” package, such as the electric range, and the shelf-mounted microwave designated for that package. As described in greater detail below, processor 108 further includes an invoice generator 110 and memory 112 for storing a plurality of invoicing rules that allow generating respective invoices formatted to meet the respective needs of the user. Although the foregoing description makes reference to Web-based applications, it will be apparent that such a reference is to be construed as illustrative and should not be construed as a limitation of the present invention.

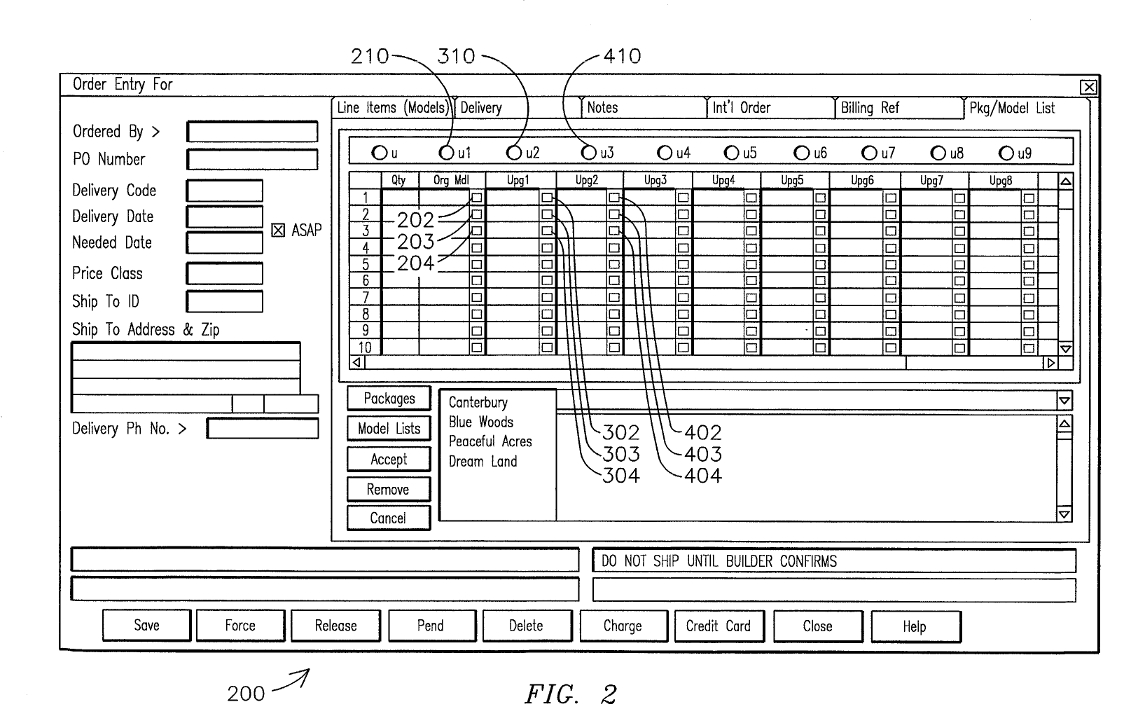

FIG. 2 illustrates a user interface 200 that allows each user to define a respective package identifier, such as Canterbury, Blue Woods, Peaceful Acres, Dream Land, etc. The user-interface further includes one or more package upgrade data fields, e.g., upgrade data fields 202-204 associated with a first package identifier, upgrade data fields 302-304 associated with a second package identifier, and upgrade data fields 402-404 associated with a third package identifier. Thus, each upgrade data field is configured to enable the user to selectively define at least a respective upgrade regarding goods and/or services associated with a respective package identifier. In addition one or more respective selectors, such as selectors 210, 310, 410, may be selected to simultaneously select each upgrade for a given package. For example, if the user selects upgrade selector 210, then every upgrade in the column under that selector would be selected. Conversely, if the user just selects update data field 202, then just the single upgrade for that data field would be selected. In this case, the respective upgrades associated with upgrade data fields 203 and 204 would not be selected. Examples of upgrades may be appliance models with additional functionality, aesthetically rare combinations of colors, larger sizes, extended warranties, etc. The user-interface may be further configured to enable the user to include goods and/or services that may be optionally supplied with a user-selected package. For example, the basic “Canterbury” package may just provide an electric range, and a shelf-mounted microwave. However, the respective homebuyer may be interested in the builder optionally adding appliances, such as clothes washer and drier.

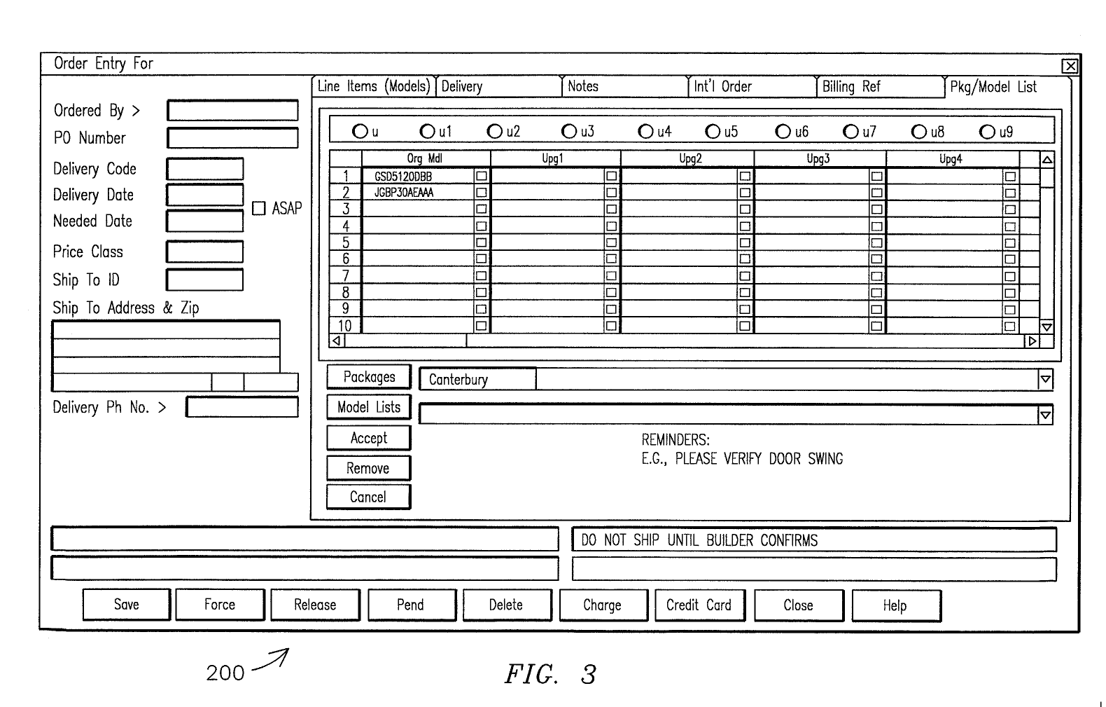

FIG. 3 illustrates a respective user-interface configured to display exemplary model identifiers associated with the “Canterbury” package identifier. As suggested above, reminders may be provided to advise the user to check for basic installation parameters, such as whether the door of the appliance swings in the right direction, etc.

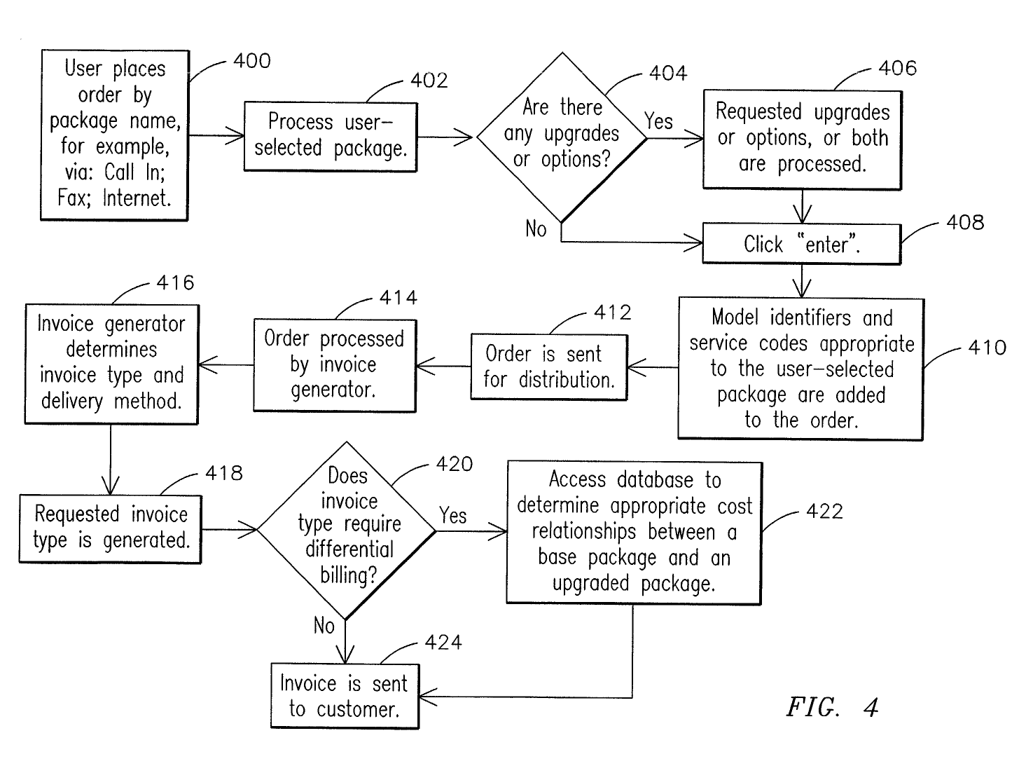

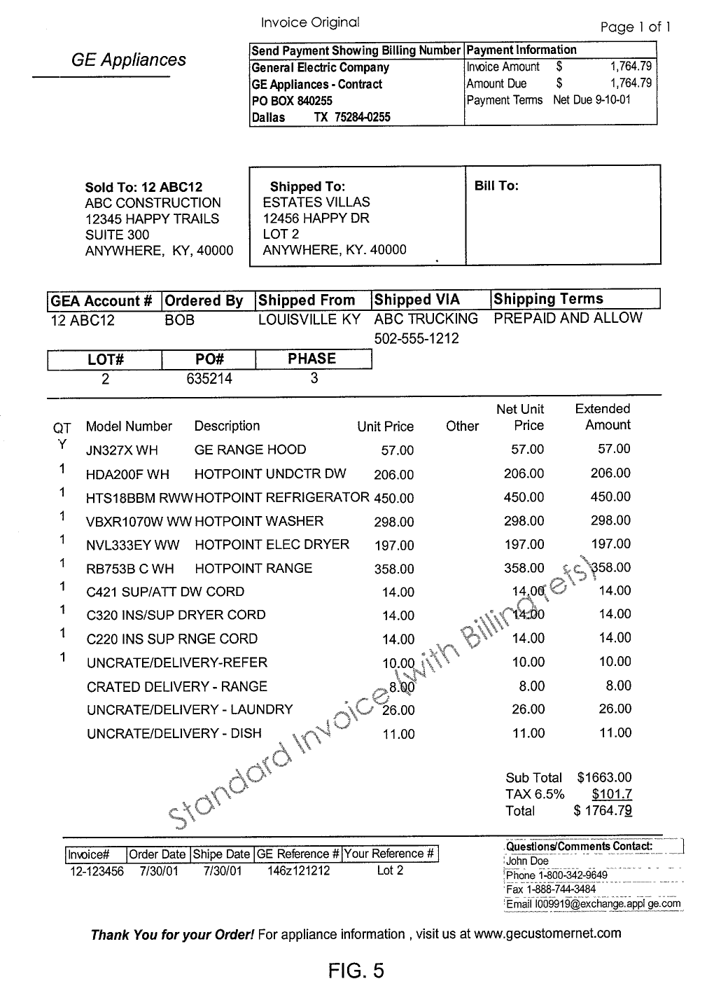

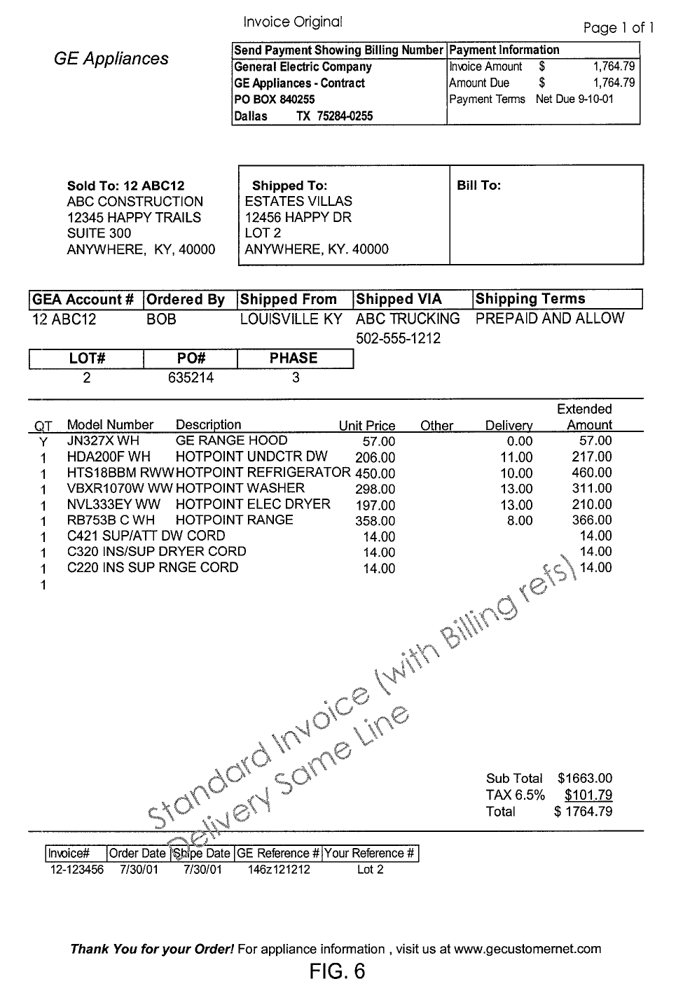

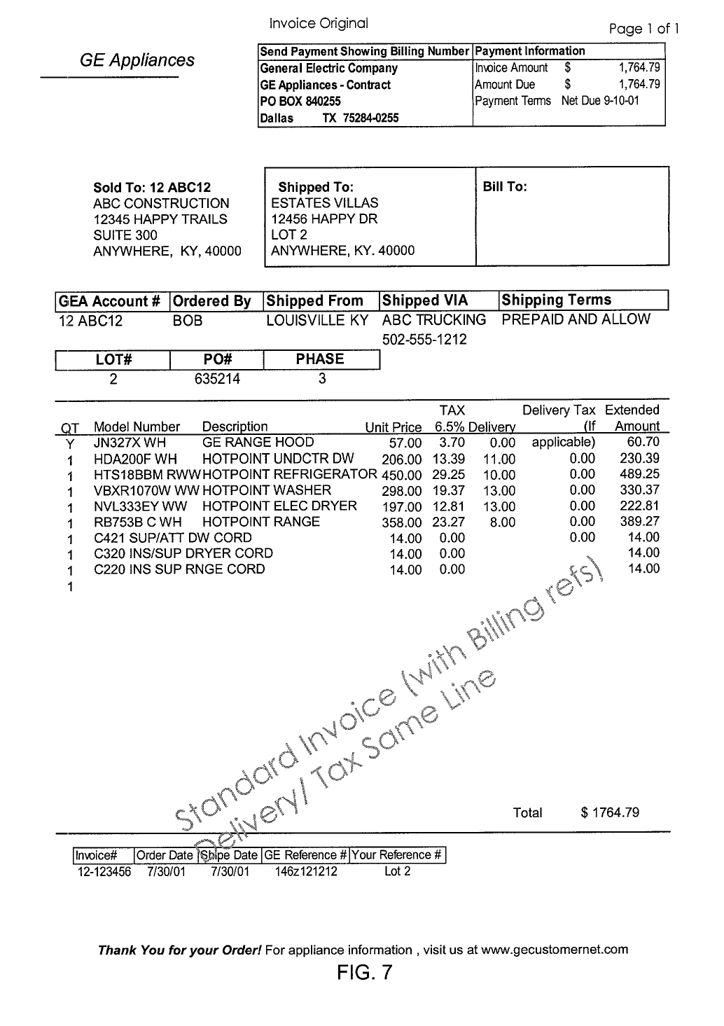

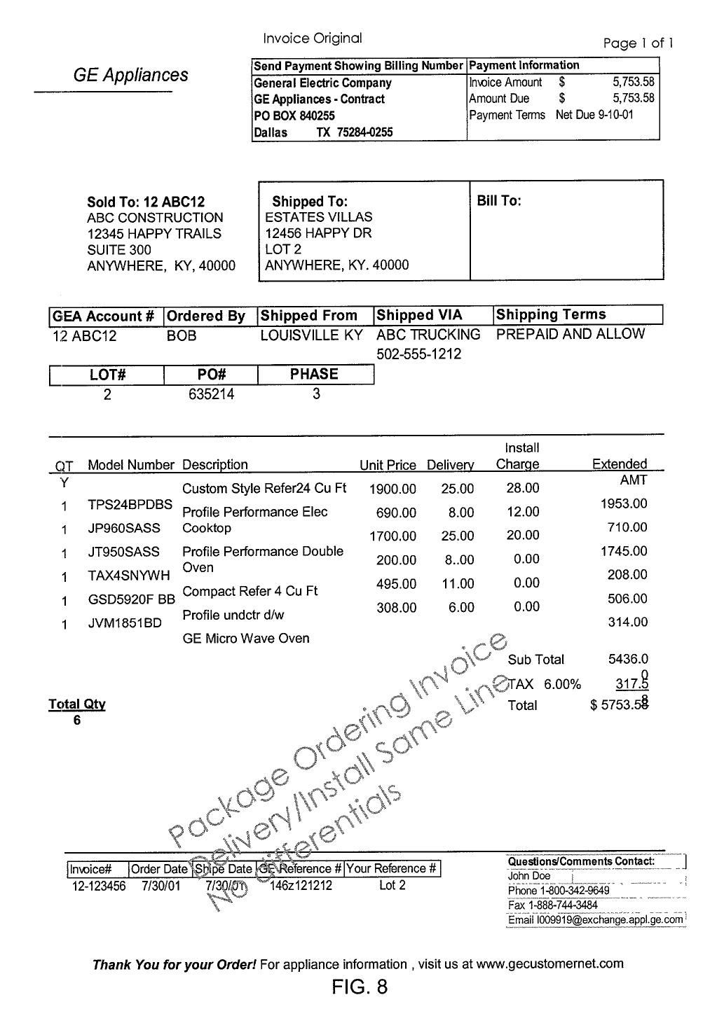

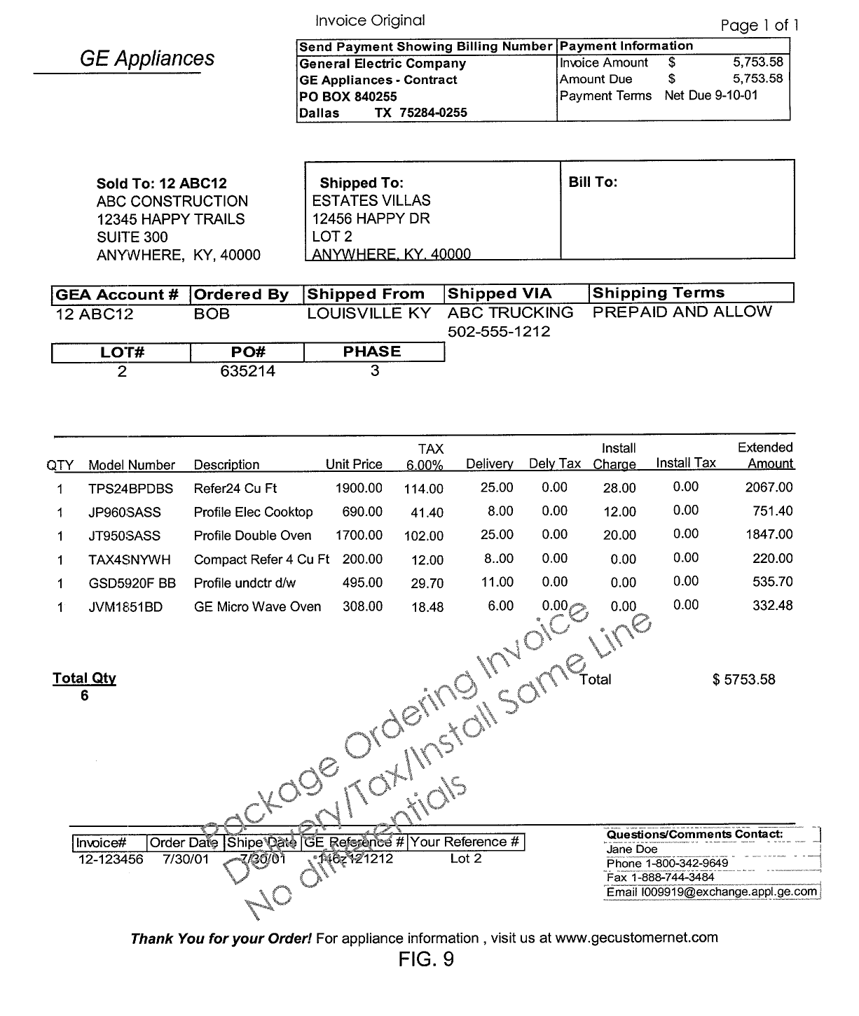

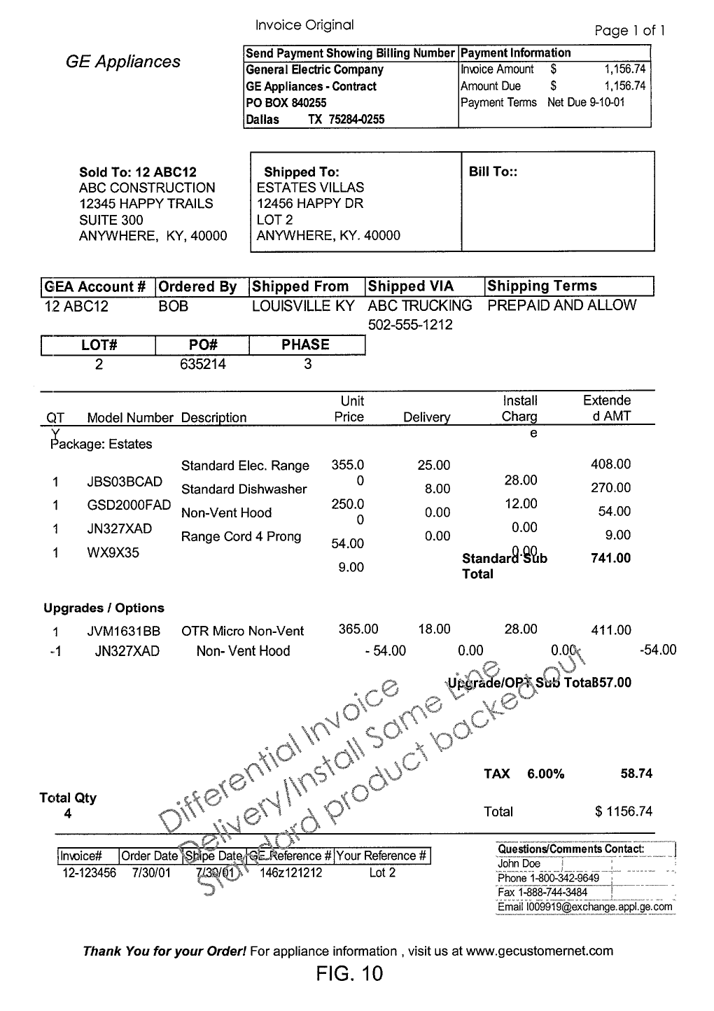

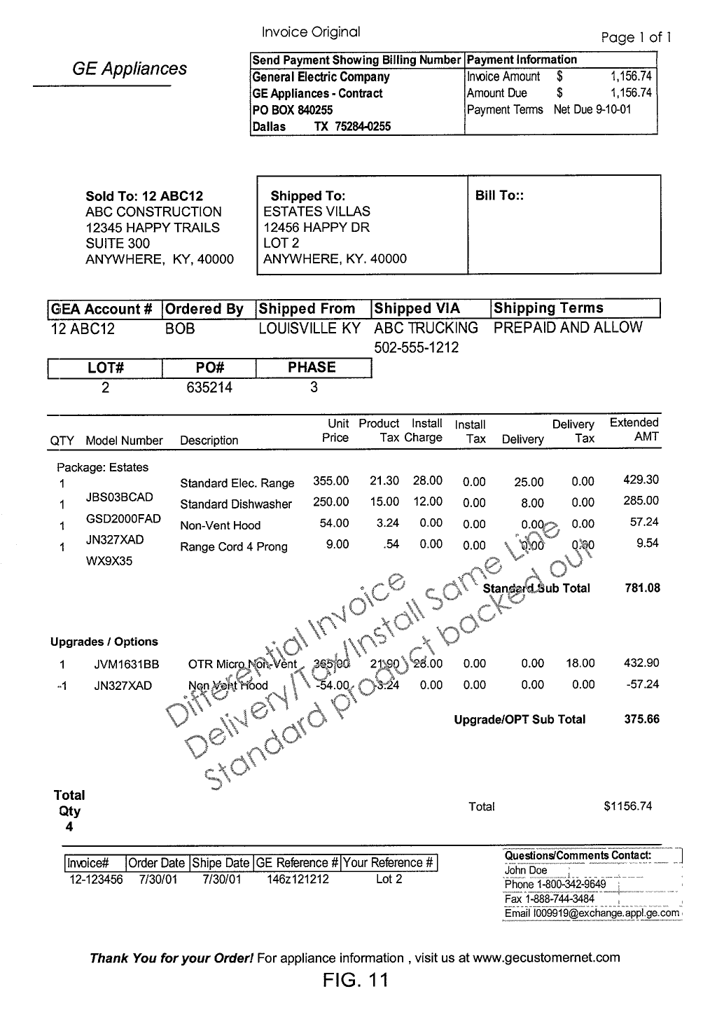

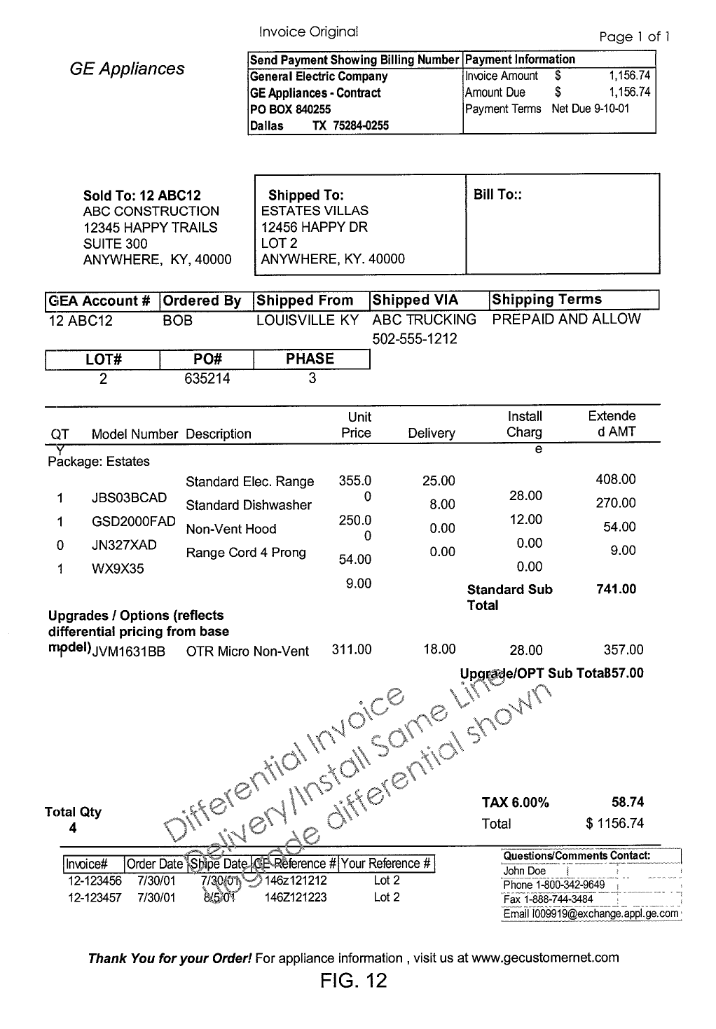

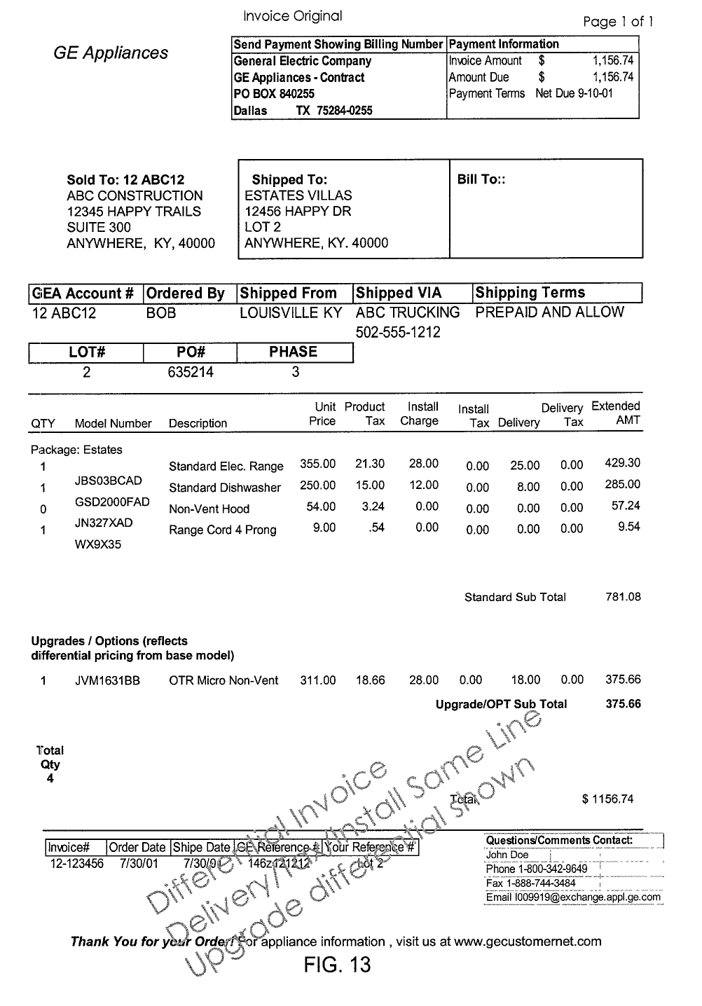

FIG. 4 is a flow chart of exemplary actions that may be performed in the context of an ordering and billing process embodying aspects of the present invention. As represented by block 400, a user places an order based on a package name or identifier (e.g., “Canterbury” package identifier) via a suitable user-interface medium, such as telephone, facsimile, Internet, etc. As shown at block 402, the user-selected package identifier is selected to be processed. Block 404 determines whether the user has requested any upgrades and/or options. In the event, upgrades, or options, or both have been requested, block 406 allows any such upgrades and/or options to be processed. Block 408 allows completing an order transaction by clicking an “Enter” icon, or key, or equivalent. Block 410 allows retrieving at least the respective model identifiers and service codes appropriate to the user-selected package. As suggested above, detailed information regarding any particular product or service may be made available to the user, such as installation notes, user guides, etc. Block 412 allows delivering the order for distribution and delivery using techniques well understood by those skilled in the art. For example, delivery of a completed order may be sent to the distribution team for appropriate scheduling and shipment to the address designated by the builder on the day requested by the builder. Block 414 allows the order to be processed by invoice generator 110 (FIG. 1). Block 416 allows determining the invoice format type and delivery means requested by a respective user. By way of example, the format choice may be selected to separately itemize invoice parameters such as taxes, service costs, installation costs, package upgrade and option costs, such as shown in the various exemplary invoice format respectively represented in FIGS. 5-14. Examples of invoice delivery may be conventional mail, E-mail, facsimile, etc.

Block 418 allows generating the requested invoice type, e.g., differential billing, or any of the various exemplary invoice formats illustrated in FIGS. 5-14. As used herein differential billing refers to an invoice configured to identify base costs associated with a user-selected package from incremental costs due to package upgrades and/or options. This billing or invoicing technique allows for quickly and accurately differentiating between costs associated with a standard package of goods versus an upgraded package of goods. Block 420 allows determining whether the requested invoice type requires differential billing. In the event differential billing is required, block 422 allows accessing database 106 (FIG. 1) for determining appropriate costs relationships between a base package and an upgraded package. Block 424 allows sending the generated invoice to the user in the medium of choice for that user. Appendix 1 illustrates an exemplary process map depicting interrelationships for accessing information from a Model List Wizard that facilitates the storage and handling of customer specific product and service needs that may be used for ordering and billing as described above.

The present invention can be embodied in the form of computer-implemented processes and apparatus for practicing those processes. The present invention can also be embodied in the form of computer program code including computer-readable instructions embodied in tangible media, such as floppy diskettes, CD-ROMs, hard drives, EEPROM, flash memories, or any other computer-readable storage medium, wherein, when the computer program code is loaded into and executed by a computer, the computer becomes an apparatus for practicing the invention. When implemented on a computer, the computer program code segments configure the computer to create specific logic circuits or processing modules.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A computerized method for ordering and billing goods and services in connection with the goods, the method customized to meet the individualized needs of users in respective market segments by enabling ordering of packages of the goods, the method comprising:
providing a user-interface to each user configured to enable the user to define at least one package identifier associated with a respective set of goods and/or services of interest to each respective user;
populating a database with at least one parameter comprising respective model identifier and service code for each good and/or service associated with each respective package identifier;
accessing the database in view of each defined package identifier to retrieve the at least one parameter for each respective package identifier; and
processing a user-selected package of goods and/or services based on a selected package identifier to generate an order of the goods and/or services associated with the selected package identifier.

2. The computerized method of claim 1 wherein the user-interface further includes a package upgrade data field configured to enable the user to define at least a respective upgrade regarding goods and/or services associated with a respective package identifier.

3. The computerized method of claim 2 wherein the user-interface further includes an option data field configured to enable the user to include goods and/or services that may be optionally supplied with a user-selected package.

4. The computerized method of claim 2 wherein the database is further populated with at least one parameter comprising respective model identifier and service code for each upgraded and/or optionally included good and service.

5. The computerized method of claim 1 wherein the user-interface further includes an invoicing-format data field configured to enable the user to select a respective invoicing format for goods and/or services included in a user-selected package.

6. The computerized method of claim 5 further comprising processing the invoicing-format selection to generate an invoice based on said invoice-format selection.

7. The computerized method of claim 5 wherein the invoicing-format selection comprises differentially identifying base costs associated with a user-selected package from incremental costs due to package upgrades and/or options.

8. The computerized method of claim 1 wherein the invoicing format choice is selected to separately itemize invoice parameters selected from the group consisting of taxes, service costs, installation costs, package upgrade and option costs.

9. The computerized method of claim 5 wherein the user interface is further configured to provide the user with a respective invoice delivery choice.

10. A computerized system for ordering and billing goods and services in connection with the goods, the system customized to meet the individualized needs of users in respective market segments by enabling ordering of packages of the goods, the system comprising:
a user-interface configured to enable the user to define at least one package identifier associated with a respective set of goods and/or services of interest to each respective user;
a database with at least one parameter comprising respective model identifier and service code for each good and/or service associated with each respective package identifier;
a module configured to access the database in view of each defined package identifier to retrieve the at least one parameter for each respective package identifier; and
a processor configured to process a user-selected package of goods and/or services based on a selected package identifier to generate an order of the goods and/or services associated with the selected package identifier.

11. The computerized system of claim 10 wherein the user-interface further includes a package upgrade data field configured to enable the user to define at least a respective upgrade regarding goods and/or services associated with a respective package identifier.

12. The computerized system of claim 11 wherein the user-interface further includes an option data field configured to enable the user to include goods and/or services that may be optionally supplied with a user-selected package.

13. The computerized system of claim 11 wherein the database is further populated with at least one parameter comprising respective model identifier and service code for each upgraded and/or optionally included good and service.

14. The computerized system of claim 10 wherein the user-interface further includes an invoicing-format data field configured to enable the user to select a respective invoicing format for goods and/or services included in a user-selected package.

15. The computerized system of claim 14 wherein the processor is further configured to process the invoicing-format selection to generate an invoice based on said invoice-format selection.

16. The computerized system of claim 14 wherein the invoicing-format selection comprises differentially identifying base costs associated with a user-selected package from incremental costs due to package upgrades and/or options.

17. The computerized system of claim 10 wherein the invoicing format choice is selected to separately itemize invoice parameters selected from the group consisting of taxes, service costs, installation costs, package upgrade and option costs.

18. The computerized system of claim 14 wherein the user interface is %further configured to provide the user with a respective invoice delivery choice.

19. A computer-readable medium for ordering and billing goods and services in connection with the goods, the computer-readable medium including instructions causing a computer to facilitate meeting the individualized needs of users in respective market segments that generally order packages of the goods by:
configuring a user-interface to enable each user to define at least one package identifier associated with a respective set of goods and/or services of interest to each respective user;
populating a database with at least one parameter comprising respective model identifier and service code for each good and/or service associated with each respective package identifier;
accessing the database in view of each defined package identifier to retrieve the at least one parameter for each respective package identifier; and
processing a user-selected package of goods and/or services based on a selected package identifier to generate an order of the goods and/or services associated with the selected package identifier.

20. The computer-readable medium of claim 19 wherein the user-interface is further configured to enable the user to define at least a respective upgrade regarding goods and/or services associated with a respective package identifier.

21. The computer-readable medium of claim 20 wherein the user-interface is further configured to enable the user to include goods and/or services that may be optionally supplied with a user-selected package.

22. The computer-readable medium of claim 20 further comprising instructions for populated the database with at least one parameter comprising respective model identifier and service code for each upgraded and/or optionally included good and service.

23. The computer-readable medium of claim 19 wherein the user-interface is further configured to enable the user to select a respective invoicing format for goods and/or services included in a user-selected package.

24. The computer-readable medium of claim 22 further comprising instructions for processing the invoicing-format selection to generate an invoice based on said invoice-format selection.

25. The computer-readable medium of claim 22 further comprising instructions for separately identifying base costs associated with a user-selected package from incremental costs due to package upgrades and/or options.

26. The computer-readable medium of claim 19 wherein the invoicing format choice is selected to separately itemize invoice parameters selected from the group consisting of taxes, service costs, installation costs, package upgrade and option costs.

27. The computer-readable medium of claim 23 wherein the user interface is further configured to provide the user with a respective invoice delivery choice.
